(19) United States
(12) Patent Application Publication
(10) Pub. No.: US 2003/0169641 A1
(43) Pub. Date: Sep. 11, 2003

(54) Time keeping system with automatic daylight savings time adjustment

(75) Inventors: Terrence J. O'Neill, Lake Geneva, WI (US); Robin W. Gollnick, Lake Geneva, WI (US); Roland W. Bihler, Lake Geneva, WI (US)

Correspondence Address: Michael Best & Friedrich LLP, 100 East Wisconsin Avenue, Milwaukee, WI, 53202-4108, US

(73) Assignee: Quartex a Division of Primex, Inc., Lake Geneva, WI

(21) Appl. No.: 10/094,100

(22) Filed: Mar. 8, 2002

(51) Int. Cl. G04B 19/22; G04C 9/00

(52) U.S. Cl. 368/21; 368/187

(57) ABSTRACT

A time keeping system used to automatically adjust for daylight savings includes a processor having a preprogrammed internal clock module, a preprogrammed daylight savings time setting module, and a low power detection module. The preprogrammed internal clock module is programmed with a time, a date, and a year. The preprogrammed daylight savings time setting module is programmed with a plurality of daylight savings changes and automatically adjusts the internal clock to reflect a daylight savings time change. The low power detection module detects an operating power level. A primary battery is operatively coupled to the processor, and provides a primary power source to the processor. A frequency generating unit is also operatively coupled to the processor, and provides a frequency to the preprogrammed internal clock module. Furthermore, a clock movement unit is operatively coupled to the processor, and is configured to receive a series of timed-pulses from the processor.

### BACKGROUND AND SUMMARY OF THE INVENTION

The present invention relates to time keeping systems and particularly to time keeping systems that adjust to daylight savings changes.

Conventional time keeping systems, such as clocks, usually require a variety of maintenance routines. The maintenance routines for power may include re-adjusting a pendulum in a gravity-powered time keeping system, rewinding a spring in a spring-driven time keeping system, or replacing batteries in a battery-powered time keeping system. Similarly, the maintenance steps for accuracy may include adjusting the time periodically, including advancing an hour during spring or retracting an hour during fall to compensate for the changes required by daylight savings time adjustment.

Many methods have been developed in an attempt to minimize, reduce, or eliminate these maintenance routines. For example, operating time keeping systems with electricity from a wall outlet or with solar cells may eliminate the power maintenance routine. Radio-controlled time keeping systems have also been developed to minimize or eliminate adjustment routines for accuracy and daylight savings time adjustment. However, these approaches add cost to the time keeping system, and restrict the areas or locations in which the time keeping system may operate. For example, a wall outlet must be available to use an electric time keeping system. Solar time keeping systems require a location with a significant source of light on a regular basis. Radio-controlled time keeping systems require locations in which radio signal reception is adequate. Therefore, a time keeping system whose operation is relatively independent of its placement whether for power or signal reception, and that still provides automatic time adjustment would be welcomed by users of time keeping systems.

According to the present invention, a time keeping system includes a processor having a preprogrammed internal clock module, a preprogrammed daylight savings time setting module, and a low power detection module. The preprogrammed internal clock module is programmed with a time, a date, and a year. The preprogrammed daylight savings time setting module is programmed with a plurality of daylight savings changes and automatically adjusts the internal clock to reflect a daylight savings time change. The low power detection module detects an operating power level. The time keeping system further includes a primary battery operatively coupled to the processor that provides a primary power source to the processor, a frequency generating unit operatively coupled to the processor that provides a frequency to the preprogrammed internal clock module, and a clock movement unit operatively coupled to the processor that is configured to receive a series of timed-pulses from the processor.

In preferred embodiments, the time keeping system further includes a reserve power backup unit operatively coupled to the processor. The reserve power backup unit receives signals from the low power detection module and provides reserve power to the processor when the primary battery is being inserted or removed. The reserve power backup unit in this embodiment is preferably a reserve battery.

The frequency generating unit is preferably a quartz crystal. The frequencies generated by crystals vary from one crystal to another and, therefore, there will generally be a discrepancy between the desired frequency required by the time keeping system and the actual quartz crystal frequency. This discrepancy or error is preferably measured and the measured error is programmed into the processor to compensate for the error.

The time keeping system further includes a standby mode that operatively uncouples the clock movement when the primary battery is removed or for a period of time after a low battery voltage is detected. The clock movement unit further includes a clock motor that is operatively coupled to the processor and is responsible for receiving the series of timed-pulses from the processor when the standby switch is closed. The series of timed-pulses in turn drives the clock motor. The series of timed-pulses preferably includes a first number of pulses per cycle when the low power detection module has not detected a low operating power and a second arrangement of the number of pulses per cycle when the low power detection module has detected a low operating power. A period of time after a low battery voltage is detected, all pulses to the clock movement may be stopped if the low voltage battery condition has not been corrected. If digital or numeric display is preferred over analog display (using hands to indicate the time), the clock movement unit may include a digital display that is operatively coupled to the processor.

According to the present invention, a method of daylight savings time keeping is also provided. The method includes coupling a primary power source to a processor. The processor having an internal clock, a daylight savings time setting, and a low power detection circuit. The low power detection circuit is configured to detect a low operating power level. The method also includes preprogramming the internal clock with a time, a date, and a year, preprogramming the daylight savings time setting with a plurality of daylight savings changes, providing the preprogrammed internal clock with a frequency, and sending series of timed-pulses from the processor to a clock movement unit (one series of timed-pulses is used to indicate an operating power level, while another series is used to indicate an elapsed time). The method also includes controlling the clock movement unit with the series of timed-pulses, adjusting automatically the internal clock to reflect a daylight savings time change, and displaying a time. Sending the series of timed-pulses further includes sending a first number of pulses per cycle when the low power detection circuit has not detected a low operating power, and sending a second arrangement of the number of pulses per cycle for a period of time when the low power detection circuit has detected a low operating power.

In a preferred embodiment, the frequency received by the preprogrammed internal clock module is preferably a quartz crystal frequency provided by a quartz crystal. The method preferably further includes measuring a quartz crystal error, preprogramming the quartz crystal error into the processor, and compensating the time with the preprogrammed quartz crystal error. The method further includes closing a standby switch when the primary battery is removed. Also the preferred embodiment includes connecting a reserve power source to the processor when the low power detection circuit detects a low operating power level or the primary battery is removed or inserted.

Other features and advantages of the invention will become apparent upon consideration of the detailed description and accompanying drawings.

### BRIEF DESCRIPTION OF THE DRAWINGS

In the drawings:

FIG. 1 shows a block diagram of a time keeping system in accordance with the present invention;

FIG. 1A shows an analog clock movement unit for use with the time keeping system of FIG. 1;

FIG. 1B shows a digital clock movement unit for use with the time keeping system of FIG. 1;

FIG. 1C shows a preferred embodiment of the time keeping system of FIG. 1; and

FIG. 2 shows a time keeping system flow diagram illustrating the functionality and operation of a time keeping system in accordance with the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

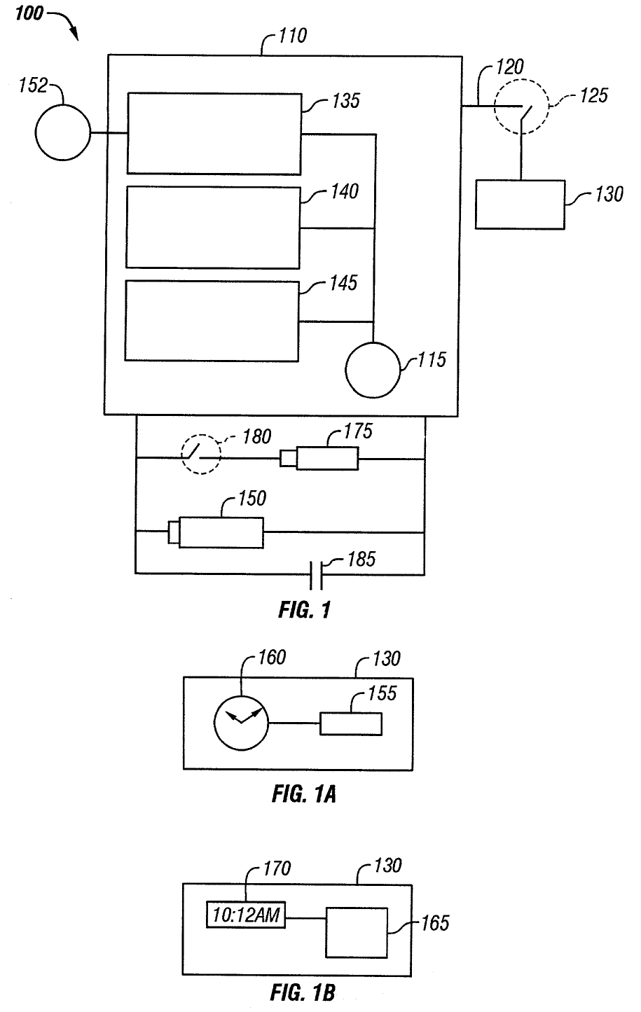

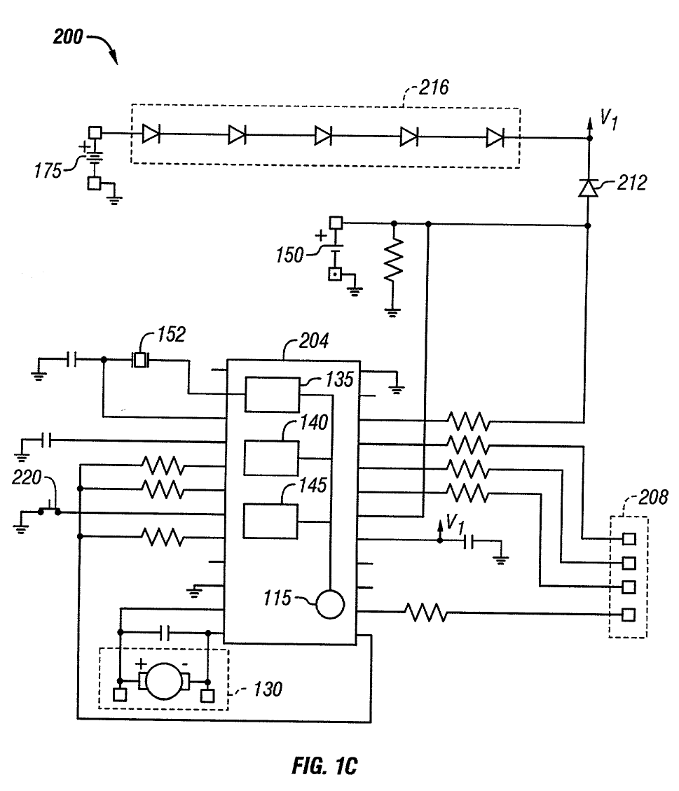

FIG. 1 illustrates the functionality of a daylight savings time clock system 100 in accordance with the present invention. The daylight savings time clock system 100 includes a processor 110, which receives programming information through a programming pad 115 and sends a series of timed-pulses from a driver output 120 through a standby switch 125 to a clock movement unit 130. The processor 110 further includes a preprogrammed internal clock module 135, a preprogrammed daylight savings time setting module 140, and a low power detection module 145. The preprogrammed internal clock module 135 and the preprogrammed daylight savings time setting module 140 are programmed with time information and daylight savings changes through the programming pad 115 during the manufacturing process. These changes preferably include dates and times for daylight savings changes and a calendar that includes a number of days in leap years, non-leap years, and millenium leap years. The low power detection module 145 detects a low operating power level in the system 100, as will be more fully discussed below.

Under normal operating circumstances, the time keeping system 100 is powered by a primary battery 150, and the internal clock module 135 is controlled by a frequency generating unit (e.g., a quartz crystal) 152. However, if the primary battery 150 is removed, a reserve power source or a backup battery 175 is coupled to the processor by closing a backup switch 180. According to the present invention, the backup switch 180 could be closed or activated in a number of different manners. The switch 180 could be manually closed by a user, or the switch 180 could be mechanically closed upon the removal of the primary battery 150. In another embodiment, the switch 180 is electronically controlled by the processor 110. To ensure that the power provided to the processor 110 is not interrupted during the battery removal or replacement process, a capacitor 185 is operatively coupled in parallel to the primary battery 150.

In a preferred embodiment of the present invention illustrated in FIG. 1C, a daylight savings time keeping system 200 includes a processor 204. The processor 204 includes the same modules and features included in the processor 110. However, the processor 204 also monitors the voltage of the primary battery 150 and, then, automatically performs the functions of the switches 180 and 125 in the event of low power detection or insertion of a new primary battery. When the processor 204 detects a low voltage output from the primary battery 150, the processor 204 disconnects the primary battery 150 and switches to the reserve power source or backup battery 175. Once the system 200 is being powered by the backup battery 175, the processor 204 deactivates the clock movement unit 130 to preserve the backup battery 175. The processor 204 does not re-activate the clock movement unit 130 until a new primary battery 150 is inserted and the processor does not detect a low voltage output from the new primary battery 150.

In the preferred embodiment shown in FIG. 1C, the daylight savings time keeping system 200 further includes a programing interface 208, which allows the internal clock module 135 of the processor 200 to be programmed with time information and daylight savings changes before or after the manufacturing process. The programming interface 208 allows the quartz crystal 152 to be measured for any degree of error between the desired frequency required by the processor 200 and the actual quartz crystal frequency. The internal clock module 135 is then programmed to make adjustments which compensate for the error.

The system 200 also includes a protection diode 212, which prevents the current generated by the primary battery 150 to reverse its flow. A diode series 216 coupled to the backup battery 175 decreases the voltage level generated by the backup battery 175 to an acceptable level required by the processor 204. The system 200 also includes a time setting interface 220. The interface 220 allows the user to set the time that is desired to be displayed. For an analog display 160 (FIG. 1A), the user manipulates the position of the hands through the time setting interface 220. For a digital display 170 (FIG. 1B), the user identifies the time illuminated on the display component 170 using the time setting interface 220.

Referring to FIGS. 1, 1A, 1B, and 1C the processor 110 (FIG. 1) or 204 (FIG. 1C) sends out a series of timed-pulses at a first number of pulses per cycle (one pulse per second, for example) to drive the clock movement unit 130. In one embodiment, the clock movement unit 130 includes a stepping motor 155 and an analog display 160 (FIG. 1A). In another embodiment, the clock movement unit 130 may include a digital display component 165 and a digital display 170 (FIG. 1B).

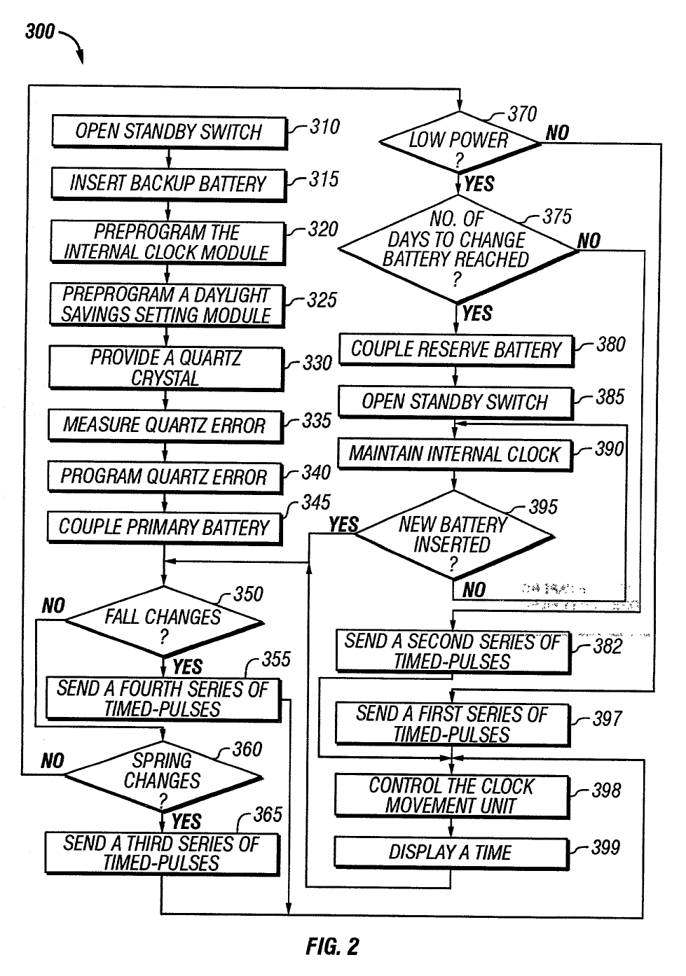

Referring now to FIG. 2, a flow diagram 300 illustrates the functionality and the operation of a daylight savings time keeping system 100 or 200 according to the present invention. The flow diagram 300 starts with a manufacturing process in which the standby switch 125 (refer back to FIG. 1 for the reference numerals relating to the structure referred to in the various steps of the process shown in FIG. 2) is opened in step 310, and a backup battery 175 is inserted in step 315. During the same manufacturing process, the internal clock module 135 is programmed with a time, a date, and a year in step 320. The daylight savings setting module 140 is also programmed with a plurality of daylight savings changes in step 325 or it may be preprogrammed during the chip manufacturing. A quartz crystal 152 is provided in step 330. The quartz error is then measured in step 335 and programmed into the processor 110 or 204 in step 340 to compensate for the difference between the desired frequency required by the processor and the actual quartz crystal frequency.

A user then sets the time keeping system 100 or 200 to a correct time with a set button (not shown) and inserts a primary battery 150 in step 345. Inserting the primary battery 150 opens the backup battery switch 180 and closes the standby switch 125 to allow a reception of pulses from the processor 110 or 204, as discussed above.

The processor 110 or 204 checks the time and the date on a regular basis against the programmed daylight savings changes in the daylight savings setting module 140. If both the date and the time agree with the preprogrammed daylight savings changes, the processor 110 or 204 will send a particular series of timed-pulses. For example, if the time calls for the retracting of time (e.g., in the fall as determined in step 350), the processor 110 or 204 sends a fourth series of timed-pulses, or one pulse per five seconds in step 355 to slow down the display time until the one hour adjustment is complete. Otherwise, if the time calls for the adding of time (e.g., in the spring, as determined in step 360), the processor 110 or 204 sends a third series of timed-pulses, or eight pulses per normal second in step 365 to speed up the display time until the one hour adjustment is complete.

If no daylight savings change is required (NO output path of step 360), the processor 110 or 204 proceeds to check for low operating power level in step 370. If the operating power level is not low, the processor 110 or 204 sends a first series of the timed-pulses. Otherwise, when the operating power level is low, and a new primary battery is not inserted to replace the drained battery 150 within a number of days (determined in step 375), the backup battery switch 180 is closed in step 380 to allow the backup battery 175 to provide power to the processor 110. Alternatively, the processor 204 automatically switches to the backup battery 175 when low voltage from the primary battery 150 is detected. A second series of timed-pulses will then be sent by the processor 110 or 204 to the clock movement unit 130. The second series of timed-pulses might preferably include two pulses every other second in step 382 to notify the user of the low operating power level. To avoid excessive drain on the reserve backup battery, the processor 204 deactivates the clock movement unit 130 in step 385 or the standby switch 125 is opened in step 385 to stop the clock movement unit 130. The internal clock module 135 is maintained and powered by the reserve battery 175 in step 390 until a new battery is inserted (determined in step 395). If a new battery 150 is inserted, the process starting in step 350 is repeated.

If the low power detection module 145 does not detect any low operating power level, the processor 110 or 204 sends a first series of timed-pulses in step 397. The first series of timed-pulses preferably includes one pulse per second to indicate a normal lapse of time. The series of timed-pulses then controls the clock movement unit 130 in step 398. For example, if an analog display is desired, the pulses will then drive the stepping motor 155 (FIG. 1A) and move the hands of the analog clock 160 (FIG. 1A) in step 399. If a digital display is desired, the pulses will then trigger the digital component 165 (FIG. 1B) and in turn the digital display 170 (FIG. 1B) in step 399. Thereafter, the entire process starting in step 350 is repeated.

Thus, the invention provides, among other things, a daylight savings time keeping system. Various features and advantages of the invention are set forth in the following claims.

1. A time keeping system comprising:
a processor having a preprogrammed internal clock module, a preprogrammed daylight savings time setting module, and a low power detection module, the preprogrammed internal clock module being programmed with a time, a date, and a year, the preprogrammed daylight savings time setting module being programmed with a plurality of daylight savings changes and automatically adjusting the internal clock to reflect a daylight savings time change, and the low power detection module detecting an operating power level;
a primary battery operatively coupled to the processor, and providing a primary power source to the processor;
a frequency generating unit operatively coupled to the processor, and providing a frequency to the preprogrammed internal clock module; and
a clock movement unit operatively coupled to the processor, and being configured to receive a series of timed-pulses from the processor.

2. The system of claim 1, further comprising a reserve power backup unit operatively coupled to the processor, the reserve power backup unit receiving signals from the low power detection module, and providing reserve power to the processor under low battery detection.

3. The system of claim 2, wherein the reserve power backup unit comprises a reserve battery.

4. The system of claim 1, wherein the frequency generating unit comprises a quartz crystal, the quartz crystal having a measured error, and the measured error being programmed into the processor.

5. The system of claim 1, further comprising a standby switch operatively coupled to the clock movement unit and the processor.

6. The system of claim 5, wherein the clock movement unit further comprises a clock motor operatively coupled to the processor, the clock motor receiving the series of timed-pulses from the processor when the standby switch is closed, and the series of timed-pulses driving the clock motor.

7. The system of claim 6, wherein the series of timed-pulses further comprises:
a first number of pulses per cycle when the low power detection module has not detected a low operating power;
a second number of pulses per cycle when the low power detection module has detected a low operating power;
a third number of pulses per cycle when the daylight savings setting module signals for daylight savings time forwarding;
a fourth number of pulses per cycle when the daylight savings setting module signals for daylight savings time retracting; and
a fifth number of pulses per cycle after an extended period of low power detection.

8. The system of claim 1, wherein the clock movement unit further comprises a digital display being operatively coupled to the processor, and the digital display displaying the time.

9. A time keeping system comprising:
a processor having a preprogrammed internal clock module, a preprogrammed daylight savings time setting module, and a low power detection module, the preprogrammed internal clock module being programmed with a time, a date, and a year, the preprogrammed daylight savings time setting module being programmed with a plurality of daylight savings changes and automatically adjusting the internal clock to reflect a daylight savings time change, and the low power detection module detecting an operating power level;
a primary battery operatively coupled to the processor, providing a primary power source to the processor;
a frequency generating unit operatively coupled to the processor, and providing a frequency to the preprogrammed internal clock module;
a reserve power backup unit operatively coupled to the processor, the reserve power backup unit receiving signals from the low power detection module, and providing reserve power to the processor under low battery detection; and
a clock movement unit operatively coupled to the processor, the clock movement unit being configured to receive a series of timed-pulses from the processor.

10. The system of claim 9, wherein the frequency generating unit comprises a quartz crystal, the quartz crystal having a measured error, and the measured error being programmed into the processor.

11. The system of claim 9, wherein the reserve power backup unit comprises a reserve battery.

12. The system of claim 9, further comprising a standby switch operatively coupled to the clock movement unit and the processor.

13. The system of claim 12, wherein the clock movement unit further comprises a clock motor operatively coupled to the processor, the clock motor receiving the series of timed-pulses from the processor when the standby switch is closed, and the series of timed-pulses driving the clock motor.

14. The system of claim 13, wherein the series of timed-pulses further comprises:
a first number of pulses per cycle when the low power detection module has not detected a low operating power;
a second number of pulses per cycle when the low power detection module has detected a low operating power;
a third number of pulses per cycle when the daylight savings setting module signals for daylight savings time forwarding;
a fourth number of pulses per cycle when the daylight savings setting module signals for daylight savings time retracting; and
a fifth number of pulses per cycle after an extended period of low power detection.

15. The system of claim 9, wherein the clock movement unit further comprises a digital display operatively coupled to the processor, and the digital display displaying the time.

16. A method of daylight savings time keeping, the method comprising:
coupling a primary power source to a processor, the processor having an internal clock, a daylight savings time setting, and a low power detection circuit, the low power detection circuit being configured to detect a low operating power level;
preprogramming the internal clock with a time, a date, and a year;
preprogramming the daylight savings time setting with a plurality of daylight savings changes;
providing the preprogrammed internal clock with a frequency;
sending a series of timed-pulses from the processor to a clock movement unit, the series of timed-pulses indicating an operating power level, and the series of timed-pulses indicating an elapsed time;
controlling the clock movement unit with the series of timed-pulses;
adjusting automatically the internal clock to reflect a daylight savings time change; and
displaying a time.

17. The method of claim 16, the method further comprising providing a reserve power source to the processor when the low power detection circuit is detecting a low operating power level.

18. The method of claim 16, wherein the frequency is a quartz crystal frequency, the method further comprising:
measuring a quartz crystal error;
preprogramming the quartz crystal error into the processor; and
compensating the time with the preprogrammed quartz crystal error.

19. The method of claim 16, the method further comprising:
closing a backup switch when the primary battery is removed or being inserted; and
opening a standby switch when the primary battery is removed or being inserted.

20. The method of claim 16, wherein sending the series of timed-pulses further comprises
sending a first number of pulses per cycle when the low power detection circuit has not detected a low operating power;
sending a second number of pulses per cycle when the low power detection circuit has detected a low operating power;
sending a third number of pulses per cycle when the daylight savings setting module signaling for daylight savings time forwarding; and
sending a fourth number of pulses per cycle when the daylight savings setting module signaling for daylight savings time retracting.
